(19) United States
(12) Patent Application Publication
(10) Pub. No.: US 2016/0195207 A1
(43) Pub. Date: Jul. 7, 2016

(54) HIGH PRESSURE BELLOWED FLEX JOINT

(71) Applicant: RSA ENGINEERED PRODUCTS, LLC, Simi Valley, CA (US)

(72) Inventor: Leslie Fernandes, La Canada, CA (US)

(21) Appl. No.: 14/983,465

(22) Filed: Dec. 29, 2015

Related U.S. Application Data
(60) Provisional application No. 62/100,396, filed on Jan. 6, 2015.

(51) Int. Cl. F16L 27/11

(52) U.S. Cl. CPC F16L 27/11

(57) ABSTRACT

A flexible high pressure ball joint for a pressurized fluid line has an outer annulus, an inner annulus, and a flexible bellows connecting a first conduit to the second conduit. The joint further includes a toroidal bearing disposed about the inner annulus and engaged at a shoulder, and a cover extending over the toroidal bearing. To reduce galling, an insert having an arcuate portion conforming to an outer surface of the toroidal bearing is disposed between said toroidal bearing and the cover.

### CROSS-REFERENCES TO RELATED APPLICATIONS

This application claims priority from U.S. Application No. 62/100,396, filed Jan. 6, 2015, the content of which is incorporated herein by reference in its entirety.

### BACKGROUND

Ball joints are used in fluid lines to impart limited flexibility for the purpose of accommodating tolerances, thermal expansion and vehicular motion. They can be used in almost any type of fluid line. However, the particular joint under consideration is adapted for use in jet aircraft pneumatic environmental control systems, and in engine bleed air ducting. Reference is made to U.S. Pat. No. 6,860,519 for an understanding of the basic operation of such joints, the contents of which are fully incorporated herein by reference.

Under high dynamic contact loads, the bearings in such joints can gall when two surfaces of similar materials slide against one another, thereby increasing the friction that can lead to increased bending moments and possibly component failure. Bearings in the prior art are also susceptible to temperature failure and deformation under high loads, leading to the loss of the pre-load and weaknesses in the joint. The present invention is designed to overcome these drawbacks and others of the prior art.

### SUMMARY OF THE INVENTION

The present invention is a flexible ball joint for high pressure lines such as those found in aircraft applications. The ball joint includes a housing enclosing a bellows that couples a first tube or conduit to a second tube or conduit. The joint includes a toroidal bearing between mating flaps of the ball component that is made of a high strength material such as steel or nickel alloys as suitable for the application. The toroidal bearing is structurally stable under nominal loads due to its strength properties, resisting deformation as is found in other ball joints. The toroidal bearing includes a spacer that prevents friction and high compressive contact loads from generating between adjacent like surfaces. The spacer minimizes friction through the use of dissimilar materials, improving the bending moment characteristics of the flexure joint. The bearing may further include a thin, graphite mesh between the outer surface of the toroidal bearing and the spacer. The spacer may be titanium, and may be perforated to allow the particulate graphite to extrude into the dynamic surface so as to further reduce the friction through “dry” lubrication. This further reduces the wear on the joint and preserves the integrity of the joint over the lifetime of the mechanism.

These and other features of the invention will best be understood as described below in the detailed description of the invention in conjunction with the associated drawings.

### BRIEF DESCRIPTION OF THE DRAWINGS

FIG. 1 is an elevated, perspective view of the ball joint;

FIG. 2 is an exploded view of the ball joint of FIG. 1;

FIG. 3 is a side view of the ball joint of FIG. 1;

FIG. 4 is a cross sectional view of the ball joint taken along lines 4-4 of FIG. 3; and

FIG. 5 is an enlarged view of the bearing assembly of FIG. 4.

### DETAILED DESCRIPTION OF THE PREFERRED EMBODIMENTS

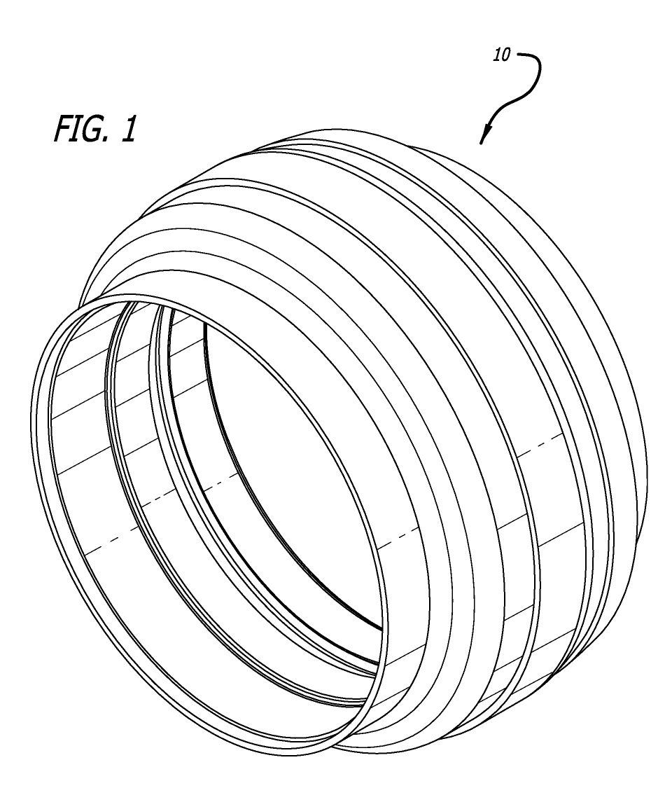

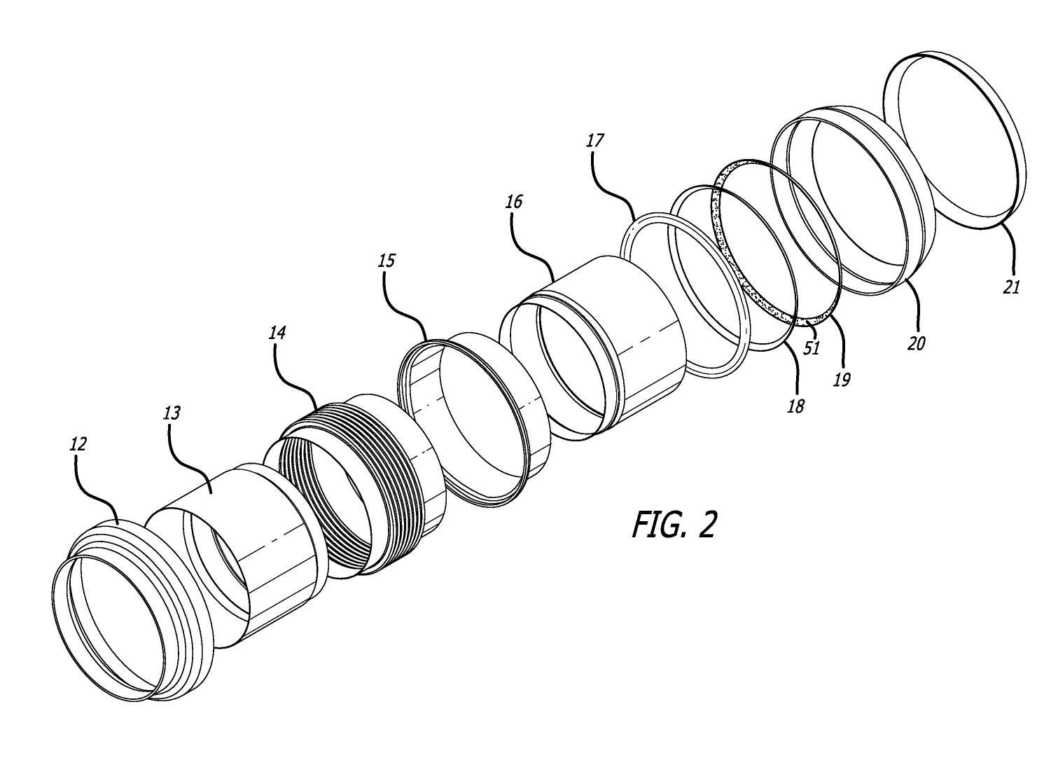

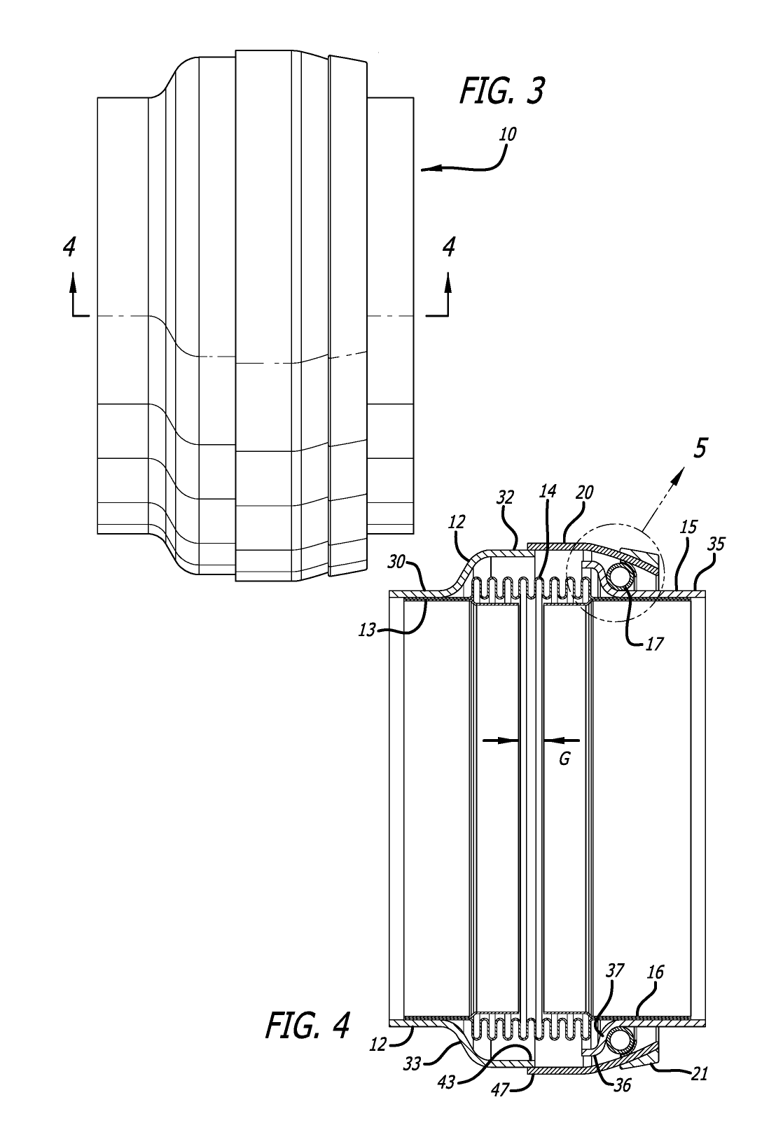

FIGS. 1 and 3 illustrate a ball joint housing 10 for a pressurized fluid line that allows for flexure of the juncture between two connecting conduits or pipes. The joint housing 10 is constructed with the following components, as shown in the exploded view of FIG. 2: outer radially reduced annulus 12, first conduit 13, coupling bellows 14, cylindrical sleeve 15, second conduit 16, toroidal bearing 17, arcuate graphite mesh 18, arcuate titanium spacer 19, frusto-conical cover 20, and cylindrical cap 21.

In FIG. 4, the arrangement of the components is best viewed for an understanding of the present invention. The outer annulus 12 has a collar portion 30 that is flush against the conduit 13, and a radially enlarged portion 32 spaced from the conduit 13 and extending over a gap G between the first and second conduits. The radially enlarged portion 32 terminates at a distal lip 43 substantially over the gap between the first and second conduits. Between the collar portion 30 and the radially enlarged portion 32 is a transition portion 33 having a sinusoidal-like shape. The conduit 13 is a tubular member through which the pressurized gas flows, in to or out of conduit 16. Connecting conduit 13 and conduit 16 is a flexible bellows 14 that accommodates flexure between the two conduits. The gap G between the conduits 13,16 is selected to permit some misalignment or bending of the line without undue stresses, which may result from a variety of onboard conditions such as vibration, thermal expansion, fluid forces, and the like. On the conduit 16 is an inner annulus 15 including a collar portion 35 adapted to mate with an outer diameter of the second conduit 16, a radially enlarged portion 36, and a transition portion 37.

Mounted on the annulus 15 is a toroidal bearing 17 that extends around the annulus and bears directly against the shoulder 37, where radially inward pressure is applied by the constraining cover 20 and cap 21. The cover 20 has two portions, a cylindrical portion terminating at a distal edge 47, where the distal edge 47 engages the distal lip 43 of the outer annulus 12 to close the ball joint, and a frusto-conical proximal portion that extends over the toroidal bearing 17. The end cap 21 bears against the cover 20 and provides closure to the joint at a proximal end, where rim 49 encloses the inner annulus 15 to seal the joint. The cap 21 may also be integral to cover 20 as opposed to a separate component.

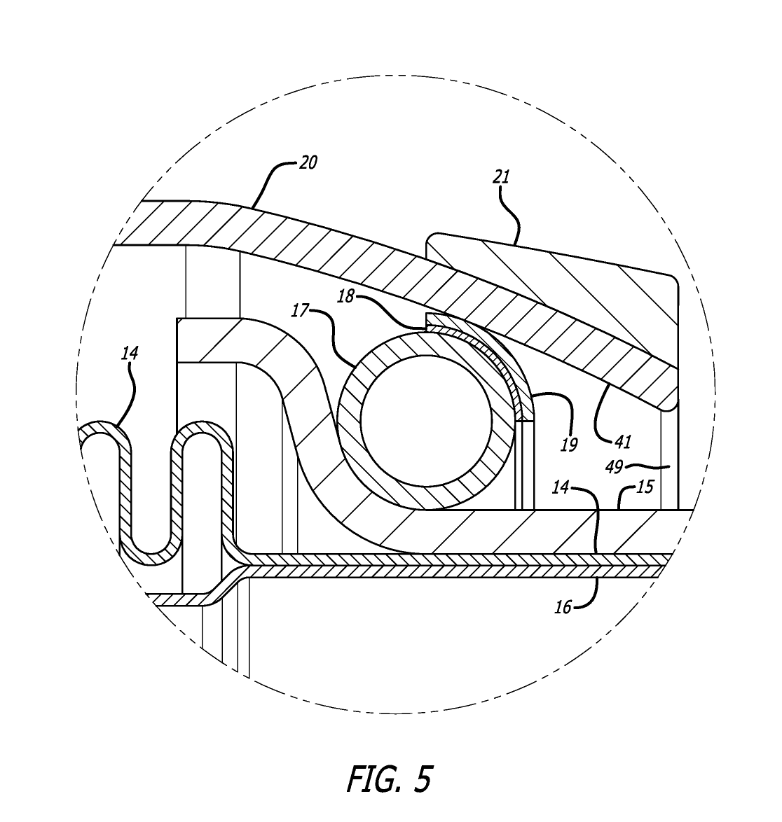

FIG. 5 illustrates the toroidal bearing 17 at the shoulder 37 of the annulus 15. The toroidal bearing 17 is preferably made of a high strength tubing such as Inconel (e.g., Inconel 625), which has temperature resistance above 1000° F. without failure. To further resist galling, an friction reducing insert 19, which is preferably made of titanium, is disposed between the toroidal bearing 17 and the cover 20. The insert 19 conforms to the shape of the outer surface of the toroidal bearing 17 and bears against the under surface 41 of the cover 20. In one preferred embodiment, a graphite mesh 18 is sandwiched between the insert 19 and the bearing 17. If the insert 19 is perforated, graphite particles from the surface of the mesh 18 will effuse through the pores in the insert 19 to lubricate the interface between the cover 20 and the insert 19, leading to even further reduced wear on the insert 19.

The toroidal bearing 17 is structurally stable under the normal compressive loads and therefore holds its preload under more severe conditions than prior art joints. Also, for components under dynamic high compressive contact loads, it is advantageous to separate similar materials from sliding contact that can cause galling and an increased bending moment. The titanium insert 19 significantly minimizes the occurrence of galling and reduces the friction which has direct impact to bending moment characteristics of the flex joint. Low bending moment is a key design feature of flex joints of this kind.

The foregoing descriptions and illustrations are not intended to be limited, and various modifications and alterations are available without departing from the present invention. Accordingly, all such modifications and alterations are intended to be considered part of the present invention. The scope of the invention is properly limited to the words of the appended claims, using their plain and ordinary meanings, in view of (but not constrained by) the foregoing descriptions and drawings.

We claim:

1. A flexible high pressure ball joint for a pressurized fluid line having first and second conduits, comprising:
an outer annulus having a collar portion adapted to mate with the first conduit at an outer diameter of the first conduit, and a cylindrical second portion of a greater radius than the first portion spaced from the first conduit and extending over a gap between the first and second conduits, the second portion terminating in a distal lip;
an inner annulus having a collar portion adapted to mate with the second conduit at an outer diameter of the second conduit, and a cylindrical second portion of a greater radius than the first portion, and a shoulder transitioning the first portion to the second portion;
a flexible bellows connecting the first conduit to the second conduit;
a toroidal bearing disposed about the inner annulus and engaged at the shoulder;
a cover having a cylindrical portion terminating at a distal edge, said distal edge bearing against and enclosing the distal lip of the outer annulus, and a frusto-conical portion extending over the toroidal bearing;
an end cap enclosing the cover at a proximal end; and
an insert having an arcuate portion conforming to an outer surface of the toroidal bearing and disposed between said toroidal bearing and said cover.

2. The flexible high pressure ball joint of claim 1, wherein the insert is perforated to allow material to pass through the insert to a mating surface between the insert and the cover.

3. The flexible high pressure ball joint of claim 2, further comprising a graphite mesh disposed between the insert and the toroidal bearing.

4. The flexible high pressure ball joint of claim 1, wherein the toroidal bearing is made of Inconel.

5. The flexible high pressure ball joint of claim 4, wherein the insert is titanium.
